(19) United States
(12) Patent Application Publication
(10) Pub. No.: US 2010/0318413 A1
(43) Pub. Date: Dec. 16, 2010

(54) ALLOCATION OF INTERNET ADVERTISING INVENTORY

(75) Inventors: Martin Zinkevich, Santa Clara, CA (US); WenJing Ma, Santa Clara, CA (US); Ramana Yerneni, Cupertino, CA (US); Jayavel Shanmugasundaram, Santa Clara, CA (US); R. Preston McAfee, San Marino, CA (US); Erik Vee, San Mateo, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/482,184

(22) Filed: Jun. 10, 2009

(51) Int. Cl. G06Q 30/00; G06F 17/00; G06F 17/30; G06F 17/11

(52) U.S. Cl. 705/14.4; 705/400; 708/207; 707/912; 707/955; 707/812

(57) ABSTRACT

A method for determining a price of a contract for booking advertising space in a networked environment includes receiving, via a web server, a request to book a number of impressions from available impression inventory, where each impression corresponds to the delivery of an advertisement to a browser. The method also includes assembling user samples that represent a total amount of impression inventory, where each user sample represents a number of internet users, calculating a value associated with each piece of remaining impression inventory of the total impression inventory, and evaluating the value of all remaining impression inventory before and after allocation to a contract by maximizing and equation subject to a set of constraints. The base price for the contract corresponds to the difference between the value of the inventory before and after allocation.

### BACKGROUND

The Internet has emerged as a powerful advertising tool. It is commonplace to see advertisements on many web sites. For example, advertisements may be displayed on search web sites and may be targeted to individuals based upon search terms provided by the individuals. Other web sites, such as news and sports web sites, may provide space for advertisements. The owners of these web sites may sell advertising space to advertisers to offset the costs associated with operating the web sites as well as to turn a profit.

In some cases, advertisers may wish to show their respective advertisements on a particular web site. Other advertisers may be less interested in specific web sites and more interested in displaying advertisements across several web sites that cater to a specified target audience. For example, an automobile advertiser may want an automobile advertisement displayed on web sites that relate to automobiles and racing.

To facilitate advertisement placement, web site operators may provide systems that allow the advertiser to book a number of impressions across web sites that target the specified audience, where each impression corresponds to the display of an advertisement to an Internet user. Booking impressions means agreeing with an advertiser to provide impressions at predetermined terms such as quantity, time period and rate. An impression is the display of an advertiser ad on a web page, which is displayed on a device of a web user. For example, the system may enable an advertiser to book 1 million impressions that target males in California. These impressions may then be allocated across several web sites that target males in California.

The number of impressions available for booking may be related to the number of impressions that were available in the past. A web site operator may use information from the past to forecast or make predictions about the number of impressions that may be available for future booking. The number of past impressions may be determined by tracking activity on the respective web sites. For example, the web site operator may track the number of visits a given web site receives. The web site operator may also keep track of the actual users that visit the web site by requiring users to register and log into the web site before utilizing the services of the web site. The data collected may be arranged within various pools of impression inventory where each pool represents a number of impressions that target a specific audience. For example, a given pool may represent 1 million impressions that target males in California, who are sports enthusiasts with a common zip code, and who viewed advertisements via a specific web site. When forecasting future impression inventory it may be necessary for a web site operator to search through various pools so as to determine whether there is enough inventory to satisfy an advertiser's order.

However, as the number of web sites available for advertising have increased, so too have the number of pools that have to be searched. The increase in the number of pools requires increased resources, such as additional storage and data processing time and power to keep track of all the pools. In addition, the time needed to search for inventory has increased as it takes more time to search through all the pools. This increase in time leads to frustration on the part of the advertiser and possible loss of revenue to the web site operator if the advertiser chooses to book impressions through a different web site operator.

### BRIEF DESCRIPTION OF THE DRAWINGS

FIG. 1 is a system for booking impressions, based on an inventory of impressions, and for serving advertisements;

FIG. 2 illustrates a first methodology for representing information stored in an impression inventory database;

FIG. 3 illustrates information utilized to characterize an inventory pool;

FIG. 4 illustrates a second methodology for representing information stored in an impression inventory database;

FIG. 5 is a flow diagram illustrating a sequence of operations for obtaining user samples from tables and lists that represent information stored in the impression inventory database;

FIG. 6 is a diagram that illustrates ? a methodology for allocating impressions to contracts based on user samples;

FIG. 7 is a flow diagram that illustrates a methodology for allocating impressions to contracts from user samples;

FIG. 8 is a flow diagram that illustrates a methodology for determining a price at which a number of impression may be booked; and

FIG. 9 illustrates a general computer system, which may represent any of the computing devices referenced herein.

### DETAILED DESCRIPTION

The embodiments below describe systems whereby a subset of available impression inventory is generated from all available impression inventory via a sampling technique. The embodiments below also describe systems whereby a contract request for booking a certain amount of inventory is received, and impressions to satisfy the contract request are allocated from the subset of available impression inventory. The following is a list of definitions of key terms used in this application:

Cookie—A cookie is information stored on a user terminal and communicated to an ad server that enables identifying a particular user terminal to the ad server. In one embodiment, all cookies are unique.

Frequency cap constraint—Corresponds to a constraint on the maximum number of times a given advertisement may be shown to an individual user during each time period (e.g., a frequency cap of 3 impressions per day per user).

Impressions—Corresponds to the display of an advertisement to an Internet user.

Property—Refers to the web site or web page through which an impression was delivered. For example, Yahoo! Finance®, operated by Yahoo! Inc. and available on the internet at finance.yahoo.com, is a property.

Position—Refers to the relative location on a web page where an advertisement may be displayed. For example, a top position may indicate that an advertisement is displayed on the top portion of a web page.

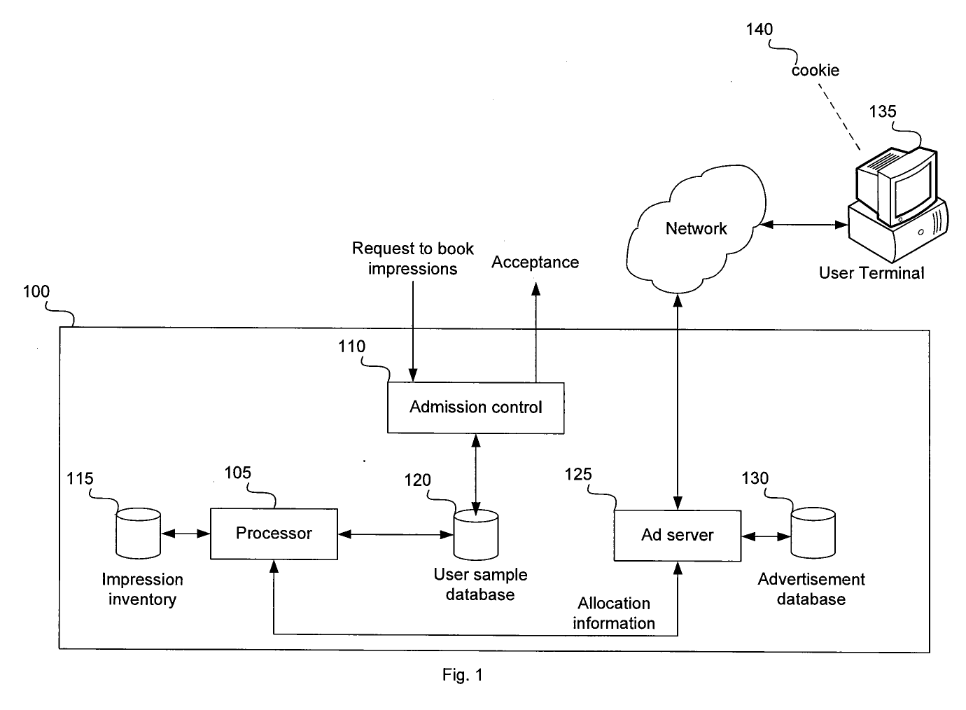

Referring now to the drawings, FIG. 1 illustrates a system 100 for booking impressions based on an inventory of impressions. The system 100 includes an admission control subsystem 110, a processor 105, an impression inventory database 115, a user sample database 120, an ad server 125, and an advertisement database 130. The various components of the system 100 may reside on a single computer or be distributed between several computers interconnected by a communication network.

The processor 105 may correspond to an Intel®, AMD®, or PowerPC® based processor operating a Microsoft Windows®, Linux, or other Unix® based operating system. Other types of data processing circuitry may be substituted as well. The processor 105 may be adapted to communicate with other computers via an interface, such as a network interface. The processor 105 may be adapted to communicate data to and from the impression inventory database 115, the user sample database 120, and the ad server 125.

The processor 105 may also be adapted to generate data defining user samples based on information in the impression inventory database 115, and to store the generated user sample data to the user sample database 120.

The impression inventory database 115 and user sample database 120 may correspond to data storage devices suitable for storing large amounts of information, such as RAM, ROM, or hard disk drives. The impression inventory database 115 may be utilized to store information related to all impressions that were delivered in the past. In one embodiment, information in the impression inventory database 115 may be updated each time an advertisement is served to a user terminal 135 via the ad server 125. For example, the ad server 125 may notify the processor 105 that an advertisement was served to a particular user terminal 135 associated with a specific cookie 140. The property through which the advertisement was delivered along with the cookie 140 may be communicated to the processor 105. The processor 105 may then store the information to the impression inventory database 115 and may also generate and store statistical information related to the user terminal 135 associated with the cookie 140. This information may enable determining characteristics associated with a user operating the user terminal 135. For example, shopping habits as well as demographic and geographic information associated with the user may be determined. In some instances, a user associated with a user terminal 135 may have provided registration information that may enable determining even more information about the user. For example, the user may have registered for a mail program, such as Yahoo! Mail®, and provided his age and address. All the determined information may be associated with the cookie 140 and stored to the impression inventory database 115.

The user sample database 120 may be utilized to store samples of users that represent all of the users represented in the impression inventory database 115. The methodologies for storing information in the user sample database 120 are described in more detail below. Information stored in user sample database 120 may be utilized by the admission control subsystem 110 to make allocation decisions.

The admission control subsystem 110 may include logic, circuitry, and/or code that enables booking orders from available impression inventory. To facilitate booking, the admission control subsystem 110 may be adapted to communicate a web page to advertisers that allows advertisers to specify targeting parameters associated with the order. For example, the web page may enable specifying the quantity of impressions sought along with information that defines the target audience to whom the impressions are to be delivered. In addition, the web page may enable uploading an advertisement and specifying the desired property or properties and position on the properties where the advertiser desires to place the advertisement.

The web page may also enable specifying a frequency cap constraint. For example, an advertiser may specify a frequency constraint of 2 in a contract order indicating that the advertisement in the contract order cannot be shown to the same user more than twice.

The admission control subsystem 110 determines the availability of impressions based on information stored in the user sample database 120, described below. After determining the quantity of available impressions, the admission control subsystem 110 may book the impression from the user sample database 120 and/or provide the available quantity of impressions back to the advertiser along with a cost associated with booking the impressions. The cost may be related to the scarcity of the impression inventory. For example, the cost per impression may decrease as the availability of the inventory of impressions increases.

Upon receiving the quantity of available impressions, along with the cost per impression, the advertiser may elect to book the impressions. Once booked, the admission control subsystem 110 allocates the impressions from the user sample database 120.

The ad sever 125 may correspond to an Intel®, AMD®, or PowerPC® based processor operating a Microsoft Windows®, Linux, or other Unix® based operating system, adapted to communicate an advertisement to a user terminal 135 in response to receiving a request to serve an advertisement from the user terminal 135. Other data processing equipment and systems may be substituted. The ad server 125 may receive the request and communicate the advertisement via a computer network, such as the Internet. In some instances, the request occurs when the user terminal 135 is navigated to a web page that was configured to display an advertisement. The web page may include browser code operative to cause the user terminal 135 to request an advertisement from the ad server 125. The request may include information about the web page navigated to along with the cookie 140 associated with the user terminal 135.

After the ad server 125 receives the request, the ad server 125 may search through the advertisement database 130 for advertisements that should be served to the user terminal 135. Information related to the served advertisement may be communicated to the processor so that the processor may record details related to the served impression, such as the cookie, property, and position associated with the served impression.

Allocating impressions based on information stored in the user sample database 120 may be significantly faster than allocating impressions directly from the impression inventory database 115, because of the size of the impression inventory database 115. In some embodiments, allocation decisions made based on the user sample database 120 may eventually be translated to the impression inventory database 115. This may occur at a time different than when the impressions are booked. For example, this may occur during periods of time when the system 100 is lightly loaded, such as 1 AM on Sunday.

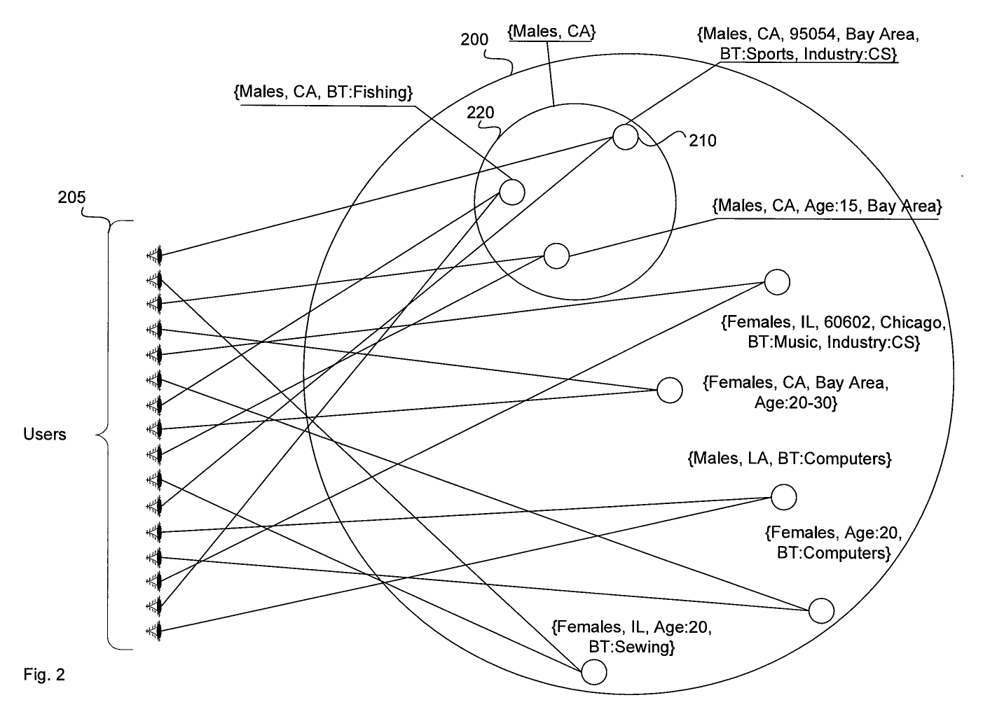

FIG. 2 illustrates a first methodology for representing information stored in the impression inventory database 115 of FIG. 1. Referring to FIG. 2, impressions stored in the impression inventory database 115 may be represented by a series of pools where each pool represents the number of impressions available that target a specific audience of users 205 that share certain attributes. A pool may be thought of as a mathematical set of impressions. In this way, some pools may be unions of other pools. For example, all the impressions may be part of a first set or pool 200. A subset pool 220 may represent the number of impressions delivered to males from California. Yet a subset of the subset pool 210 may represent the number of impressions available to males from the Bay area in California who have the zip code 95054 and are sports enthusiasts.

The number of impressions available within a pool may be based on the number of impressions delivered to users with known characteristics. In some embodiments, this number may be determined by tracking activity on the web sites that host advertising. For example, web site operators may track the number of visits a given web site receives. The web site operator may also keep track of the actual users that visit the web site by requiring the users to register and log into the web site before utilizing the services of the web site. This information may also be determined via information gathered by an ad server, such as the ad server ad server 125 of FIG. 1, as described above.

The size of a pool varies with the number of impressions it represents. For example, a pool that represents the number of impression delivered to individuals that live in a very small city may be smaller than a pool that represents the number of impressions available to users that live in a large city. The larger the pool, the more forecastable the size of the pool. That is, the larger the pool the more easy it may be to forecast or predict the size of the pool on a future date.

Generally, the more fine grained or specified a pool, the fewer the number of delivered impressions the pool represents. For example, the size of a pool that represents the number of impressions delivered to males will most likely be larger than the size of a pool that represents the number of impressions viewed by males from a particular state, who have a given hobby, because the first pool also represents impression delivered to males in different states and/or who have a different hobby.

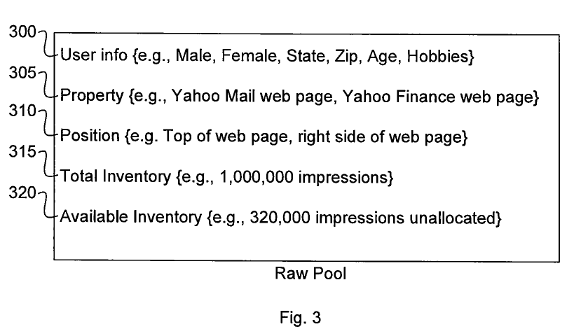

FIG. 3 illustrates information utilized to characterize a pool. Information associated with a pool may include user information 300, property information 305, position information 310, total inventory information 315, and available inventory information 320. The user information 300 includes data that defines characteristics of the users associated with the impressions represented in the pool. For example, the user information 300 may include the sex, age, and geographic information associated with the users. The property information 305 defines the web site or web page to which impressions are delivered. For example, the property information 305 may correspond to a sponsored search web site, such a Yahoo! Search®, or email web site, such as Yahoo! Mail®.

The position information 310 corresponds to the location of the advertisements on the web pages above. For example, the position information 310 may indicate that the impressions are to be delivered via a region at the top, bottom or side of a web page.

The total inventory information 315 corresponds to the number of impressions that the pool represents before booking and the available inventory information 320 corresponds to the number of impressions available for booking. The types and content of information illustrated in FIG. 3 is exemplary only and may be supplemented with any suitable information useful to a particular advertiser.

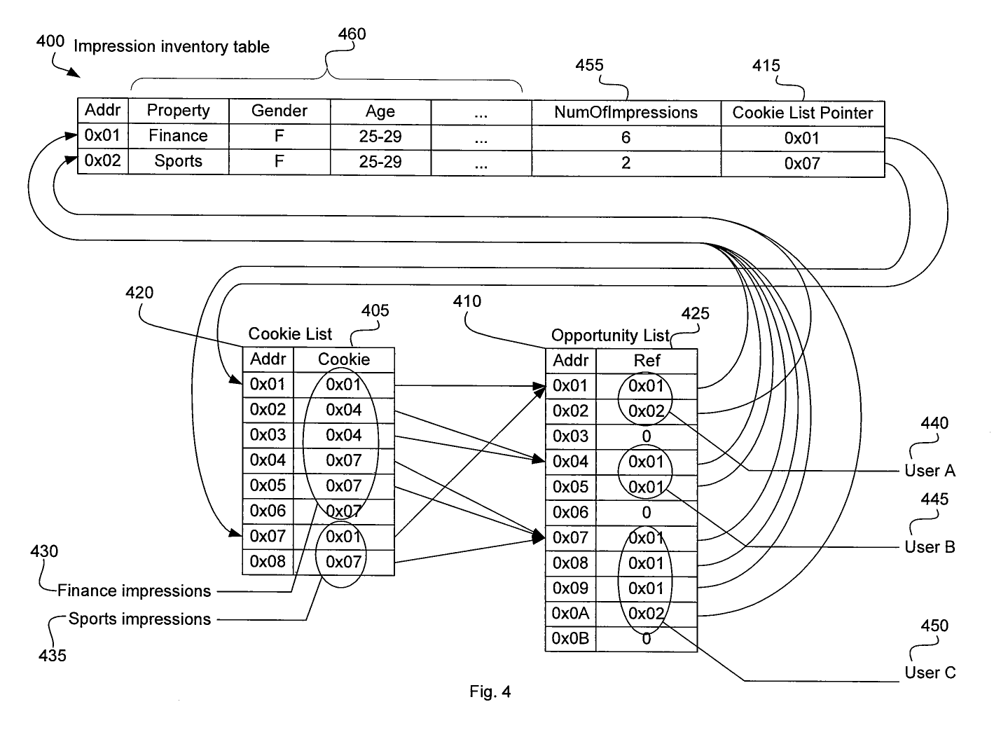

FIG. 4 illustrates a second methodology for representing information stored in the impression inventory database 115 of FIG. 1. FIG. 4 shows an impression inventory table 400, a cookie list 420, and an opportunity list 410. The impression inventory table 400, cookie list 420, and opportunity list 410 may correspond to database tables and may be stored in the impression inventory database 115 or a different database. The respective tables enable representing impression inventory on a user by user basis. That is, the tables enable determining which impressions were delivered to specific users rather than pools of users that potentially represent numerous individuals.

The impression inventory table 400 includes target parameter columns 460, a number of impressions column 455, and a cookie list pointer column 415. Each entry in the impression inventory table 400 represents impressions that share common attributes. For example, the first entry in the impression inventory table 400 represents impressions that were delivered via a finance website to females between the ages of 25 and 29. The second entry in the impression inventory table 400 represents impressions that were delivered via a sport website to females between the ages of 25 and 29. Other attributes may be utilized to characterize delivered impressions, such as the geographic location, IP address, browser type, operating system type, and property position associated with the delivered impression. Each entry in the impression inventory table 400 also includes a cookie list column 415 for specifying a cookie list pointer. The cookie list pointer corresponds to a location in the cookie list 420 where individual impressions associated with a given entry in the impression inventory table 400 are represented.

The cookie list 420 corresponds to a list of cookies associated with delivered impressions. The cookies in the cookie list 420 are organized according to the entry in the impression inventory table 400 that they are referenced to. For example, the six cookies beginning at address 0x01 430 are associated with the first entry in the impression inventory table 400 and correspond to finance impressions. The two cookies beginning at address 0x07 435 are associated with the second entry in the impression inventory table 400 and correspond to sports impressions.

Each cookie in the cookie list 420 is associated with a specific user terminal through which an impression was delivered. In addition, each cookie in the cookie list 420 is also a pointer into an opportunity list 410 that groups impressions according to the cookie associated with the opportunity.

The opportunity list 410 includes a list of pointers to entries in the impression inventory table 400. Each instance of a pointer represents an impression delivered to a user terminal or user based on a given cookie. Impressions delivered to the same user terminal, are grouped into a null terminated list. For example, impressions associated with user A 440 begin at address 0x01. In the case of user A 440, two impressions were delivered because there are two pointers. The first impression delivered was characterized by the information in the first entry of the impression inventory table 400. For example, the first impression was viewed via a finance web page. The second impression viewed by user A 440 occurred via the sports web page. The list of impressions delivered to user A 440 end with a null or zero entry below the last impression.

Similarly, impressions associated with user B 445 begin at address 0x04. In the case of user B 445, two impressions were delivered and both impressions were delivered via the finance property as indicated by the presence of two pointers to address 0x01 of the impression inventory table 400. Finally, four impressions were delivered to user C 450. Three of the impressions were delivered via the finance property as indicated by the presence of three references to the address associated with the finance property. The fourth impression was delivered via the sports property as indicated by the presence of the pointer associated with the sports property in the impression inventory table 400.

The tables described above enable quickly locating users to whom impressions were delivered. For example, suppose a list of users matching the targeting characteristics specified in the target parameter columns 460 of the first entry of the impression inventory table 400 is needed. In this case, the users may be located by simply jumping to the address in the cookie list 420 corresponding to the cookie list pointer. The cookies associated with the users are sequentially listed in the cookie list. Because the users are stored sequentially as opposed to randomly throughout the cookie list 420, the users associated with a given entry of the impression inventory table 400 may be determined more quickly. For example, in many cache based computer systems, when accessing data at a given address, the memory controller may read in several bytes of adjacent data along with the data needed. The data is read from a RAM and stored to a cache memory. Data stored in the adjacent addresses may be subsequently accessed directly from the cache, which is typically much faster to access than a RAM.

The same applies when the actual impressions associated with a specific user are required. In this case, each cookie in the cookie list 420 points to the address in the opportunity list 410 where all the impressions for a given user are stored sequentially. Because the impressions are stored sequentially, the data associated with the impressions may be determined more quickly as described above.

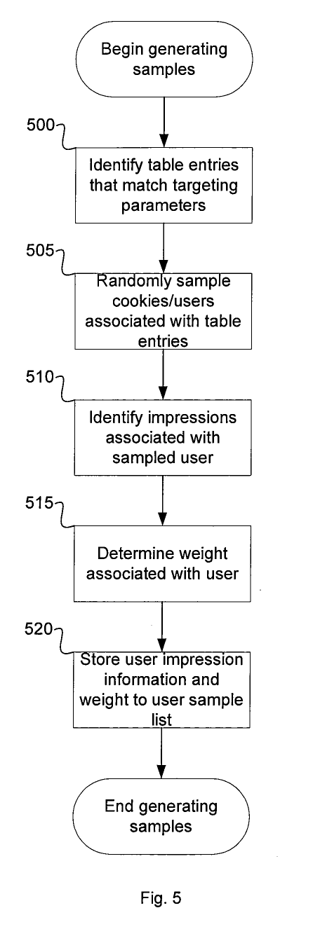

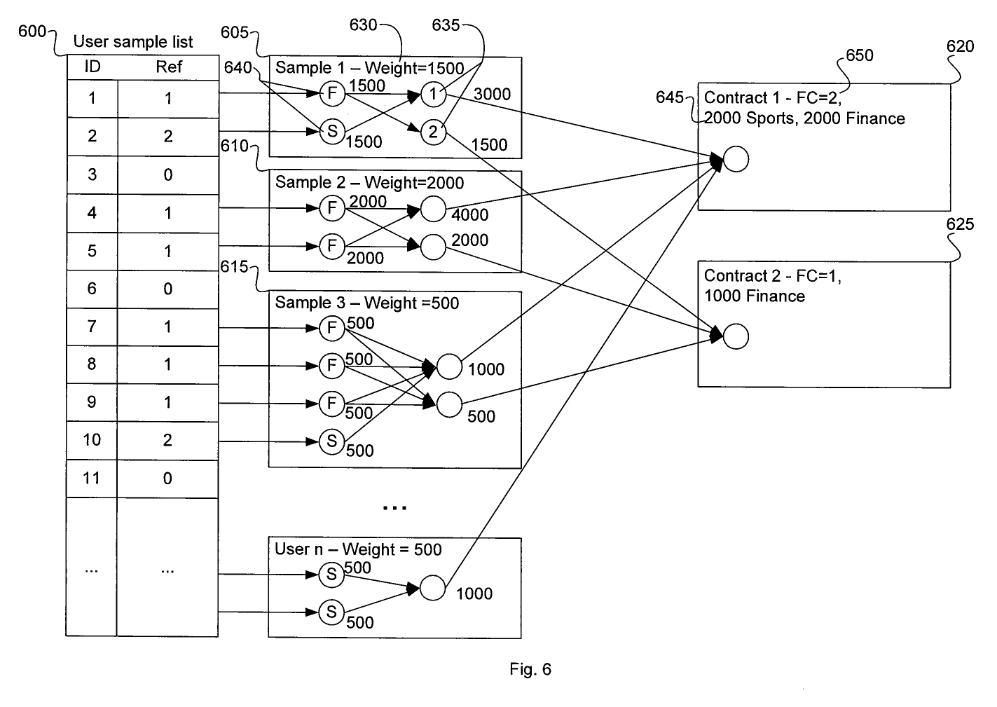

FIG. 5 is a flow diagram illustrating a sequence of operations for obtaining user samples from the tables and lists of FIG. 4. As described below in FIG. 6, the allocation of impression inventory to contracts is based on the user samples. Referring to FIG. 5, at block 500, table entries that match targeting parameters are selected. For example, if the target parameter corresponds to all finance properties, then, referring FIG. 4, the first entry of the impression inventory table 400 may be selected as that entry represents impressions delivered via a finance property, such as Yahoo! Finance®. Other entries, not shown in the impression inventory table 400, may also be selected if those entries also represent impressions delivered via a finance property. If the targeting parameters are more fine grain, that is more specific, then the number of entries that may match those parameters may be fewer. For example, if the targeting parameters also specified impressions delivered to females between the ages of 25-29, then it may be the case that only one entry represents impressions delivered on that basis.

After the table entries have been identified, users associated with the tables entries may be randomly sampled at block 505. Referring again to FIG. 4, the number of impressions delivered that are associated with each table entry is equal to the value specified in the NumOfImpressions column 455 of the impression inventory table 400. Cookies associated with the users to whom those impressions were delivered are stored sequentially in the cookie list 420, with the first cookie being stored at the address specified by the cookie list pointer value. For example, 6 impressions are associated with the first table entry of the impression inventory table 400. The cookies associated with those 6 impressions are stored sequentially at address 0x01 in the cookie list 420. In some cases, more than one impression may have been delivered to the same user on a given day. In this case, the entries associated with that user may be repeated in the cookie list 420. After the users, via their respective cookies, have been located, some of the users may be randomly sampled.

In order to represent the users correctly, in the ideal case each user with the same probability is sampled. However, some users are more likely to be sampled than others, because they may have more targeted impressions in them, or impressions that are more likely to be selected. This problems is addressed by associating a weight with each user at block 515, which is described below.

At block 510, the impressions associated with the randomly sampled user may be determined. Referring again to FIG. 4, the actual value of the cookie stored in the cookie list 405, corresponds to a pointer into the opportunity list 410 where a value that represents the impressions delivered to a given user are stored. For example, values in the opportunity list 410 associated with user A 440 correspond to 0x01 and 0x02. These two values correspond to pointers into the impression inventory table 400, meaning that user A 440 was delivered an impression via the finance property once and via the sports property once. Two impressions are associated with user B 445, because user B 445 was delivered two impressions via the finance property. Three of impressions were delivered to user C 450 via the finance property and one via the sport property.

At block 515, the weight associated with each user sample is determined. In one embodiment, the weight is determined by the following equation:

$$Weight = ( \frac{\# Users}{\# Users\_sampled} ) \times ( \frac{Pr [ user\_sampled \_uniformly ]}{Pr [ user\_sampled ]} )$$

The first factor is the course weight. For example, when 100 samples are drawn from 1000 users, the course weight corresponds to 10. The second factor is derived from importance sampling. In this case, Pr[user sampled uniformly]=1/(# users). Therefore, the second factor can be rewritten as:

$$( \frac{1}{( Pr [ user\_sampled ] \times \# Users\_sampled )} )$$

Pr[user sampled]=(Pr[first impression of user sampled]+Pr[second impression of user sampled]+ . . . +Pr[last impression of user sampled])

For instance, suppose that 200 impressions are sampled. 100 impressions are sampled uniformly from those matching finance contract 2 (and the users who created those impressions), and 100 impressions are sampled uniformly from those matching sports or finance contract 1 (and the users who created those impressions). Then, each sample has a probability of (½) to be from contract 2 (6 impressions), and a probability of (½) of being from contract 1 (8 impressions).

So, looking at user A, the first impression matches contract 1 and 2 (Pr[first impression of user A]=(½)×(⅙)+(½)×(⅛)=( 7/48)) and the second impression matches contract 2 (selected with probability Pr[second visit of user A]=(½)×(⅛)=( 1/16)).

Therefore, Pr[user A sampled]=( 7/48)+( 1/16)= 5/24

Weight of A (if sampled once)=1/(( 5/24)×200)=0.024

The reason that this weight is so low is that there are 200 sampled users, but only 3 real users.

Pr[user B sampled]=( 7/48)+( 7/48)= 7/24

Weight of B (if sampled once)=1/( 7/24)×200)= 24/1400 or approx. 0.017.

B has a smaller weight than A because both impressions of B match both contracts.

Pr[user C sampled]=( 7/48)+( 7/48)+( 7/48)+( 1/16)=½=0.5

Weight of C (if sampled once =1/((½)×200)= 1/400=0.0025

Since C is the most likely to be sampled, it has the smallest weight.

Note that ( 5/24)+( 7/24)+(½)=1, as would be expected.

At block 520, information that defines a user sample may be stored in a user sample list as described below. The user sample list may reside in a database, such as the user sample database 120. The number of users represented by each user sample may correspond to the weight of the user sample. The information stored may include the weight of the user sample as well as targeting information associated with users represented by the user sample, such as the gender and age of the users the sample represents. In addition, the properties through which impressions were delivered to users represented by the sample may also be stored. During booking, the user sample list may be utilized to predict the number of impressions available for booking a given contract as described below.

FIG. 6 illustrates a methodology for allocating impressions to contracts based on user samples. Shown in the diagram is a portion of a user sample list 600 along with a more detailed representation of the data associated with first, second, and third user samples 605, 610, and 615. Also shown, are contract 1 620 and contract 2 625. For simplicity, the information in the user sample list 600 matches the information in the opportunity list 425 of FIG. 4. However, in normal practice, the user sample list 600 would represent a sample of the users in the opportunity list 425.

Each sample has a weight 630, property nodes 640, and contract nodes 635. As described above, the weight 630 corresponds to the number of actual users the sample represents. The property nodes 640 represent properties through which impressions were delivered to users represented by the sample. For example, sample 1 605 has a weight 630 of 1500, meaning that sample 1 605 represents 1500 users. Each user represented was delivered one impression via a finance property and one impression via a sports property, as indicated by the two property nodes 640 labeled “F” and “S,” respectively. Thus, the total number of impressions actually delivered to users represented by sample 1 605 corresponds to 3000 impressions, 1500 impressions delivered via the finance property and 1500 impressions delivered via the sports property. Stated differently, two impressions were delivered to each user represented by sample 1 605.

The contract nodes 635 represent conduits through which impressions flow to individual contracts. For example, the contract node 635 labeled 1 links the “F” and “S” property nodes 640 to contract 1 620, because contract 1 620 allows both sports and finance impressions. The contract node 635 labeled 2 links only the “F” property node to contract 2 625 because contract 2 625 allows only finance impressions.

The maximum number of impressions that may flow from a given sample to a particular contract depends in part on the weight 630 of the sample, the source of the impressions in the sample, and the targeting requirements 645 of the destination contract. For example, a maximum of 3000 impressions may be delivered from sample 1 605 to a contract that specifies both sports and finance properties. But only 1500 impressions may be delivered from sample 1 605 to a contract that specifies either sports or finance, but not both.

The maximum number of impressions that may flow from a given sample to a particular contract may also depend on a frequency capping constraint 650 in the contract. For example, suppose a contract requires both sports and finance impressions, but specifies a frequency capping constraint of 1. In this case, only 1500 impression may flow from sample 1 605 to that contract, because to allow any more than 1500 impressions to flow would necessarily require delivering impressions to one or more users more than one time. For example, in order to deliver 1501 impressions, all the impression associated with the “F” property node 640 and one impression associated with the “S” property node 640, or visa versa, must be delivered. This means that one person would see the advertisement associated with contract 1 620 twice, once when he visits a sports property and once when he visits a finance property.

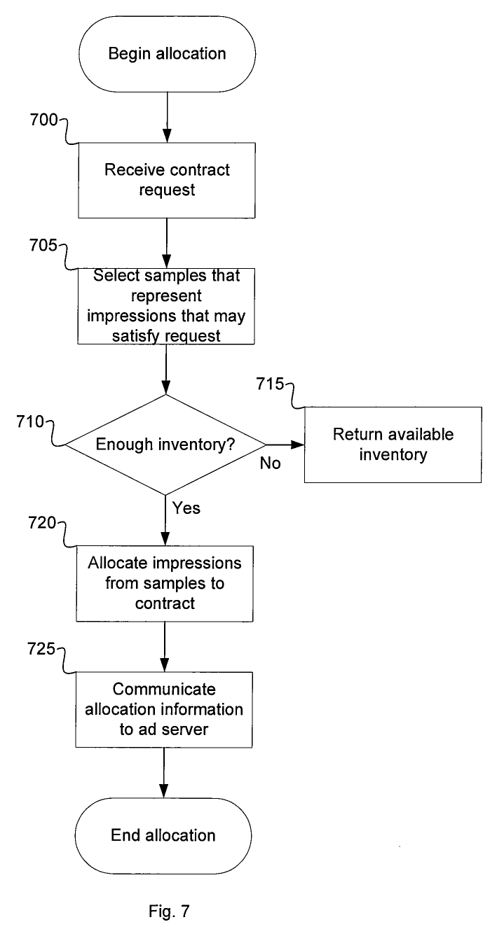

FIG. 7 is a flow diagram illustrating a methodology for allocating impressions to contracts from the samples described above. At block 700, a contract for booking advertisement impressions may be received. For example, referring to FIG. 1, an advertiser may enter a request for purchasing impression inventory via the admission control subsystem 110. The request may include and an advertisement, along with targeting parameters, such as demographic and geographic information that characterizes the desired viewing audience along with a list of properties through which the advertiser would like to advertise. The contract request may also specify the number of impressions the advertiser would like to purchase and also a frequency capping constraint for limiting the number of times an individual user may see a given advertisement.

At block 705, previously generated user samples may be analyzed so as to determine whether the contract can be satisfied. For example, referring to FIG. 6, samples that represent users characterized by the targeting parameters specified in the contract may first be identified. For instance, if the targeting parameters specify females between ages 25 and 30 who viewed impressions via a sports web page, samples that represent users with the same characteristics may be identified.

After the samples are identified, the number of available impressions each sample has available is determined. For example, referring to FIG. 6, 1500 sports impressions and 1500 finance impressions may be available from users represented by sample 1 605. 4000 finance impressions may be available from users represented by sample 2 610.

At block 710, a determination is made as to whether the impressions associated with the selected samples are enough to satisfy the contract request. In making this determination, the properties through which the impressions were delivered for each sample as well as the frequency capping constraints are taken into consideration, as described with reference to FIG. 6 above.

At block 720, if enough inventory is available, an appropriate number of impressions may be allocated from one or more of the samples to the contract. For example, if the targeting parameters of the contract specified only sports impressions, then only sports impressions may be allocated from the various samples. So, in the case of sample 1 605 of FIG. 6, only impressions associated with the sports property node 640 may be allocated and not those impressions associated with the finance property node 640.

The impressions may be allocated across the various samples so as to improve the representativeness of the impressions. For instance, impressions may be allocated from samples that represent females, and also samples that represent males, so long as these samples otherwise match the targeting parameters of the contract. Allocating to only one group or the other may not provide the representativeness that the advertiser is seeking. For example, it may be the case that all the impressions may be allocated from a sample that represents only females. However, the advertiser may prefer that the impression be delivered to people of both gender. Allocating the impressions across multiple samples may provide better results for the advertiser.

After the impressions are allocated, a value corresponding to the number of impressions allocated from each sample is deducted from the appropriate sample. For example, if 500 finance impressions are allocated from sample 1, then the number of impressions available from the finance property node 640 of sample 1 may be reduced by 500.

Returning to block 710, if the number of impressions available cannot satisfy the contract request, the number of impressions available may be communicated back to the advertiser. For example, the admission control subsystem may communicate the number of impressions available to the advertiser via a web page.

At block 725, if the allocation is successful, allocation information is communicated to an ad server, such as the ad server 125 of FIG. 1. The allocation information directs the ad server as to how an advertisement associated with a contract is to be delivered. For example, if the contract request specified a frequency capping constraint of 2, the ad server may be configured to limit the number of times the advertisement associated with the contract is communicated to the same users to two times.

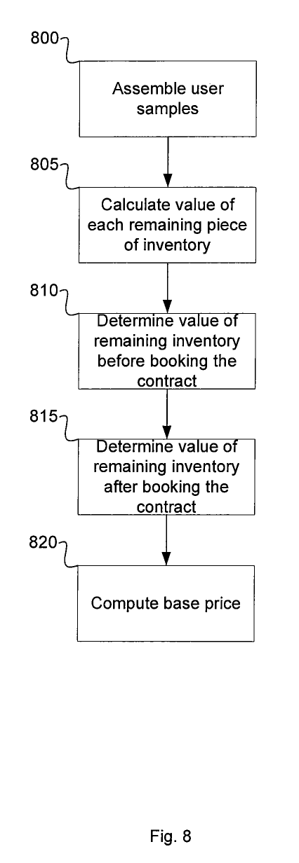

FIG. 8, described in more detail below, illustrates one methodology for determining a price at which a number of impressions may be booked. The general methodology of determining the prices begins by determining the cost associated with accepting a contract.

Cost of Accepting=Cost if Accepted−Cost if Not Accepted

In terms of the remaining inventory:

Cost of Accepting=Value of Remaining if Not Accepted−Value of Remaining if Accepted

This provides a baseline to charge for the contract. Although this may be the price, the distribution may also be calculated over values to the advertiser. If the probability the advertiser would pay p dollars was known, the following could be calculated:

argmaxₚ Pr[Customer Would Pay p](p−Cost of Accepting)

A simple model of the price of selling a particular opportunity may be used. For instance, suppose that the remaining finance opportunities are estimated to be worth $10 CPM (cost per thousand), whereas the remaining sports opportunities are worth $5 CPM. Assume that there are 1000 finance opportunities and 1000 sports opportunities.

If some advertiser asks for 750 opportunities of either finance or sports (or a mixture of both), the value of the remaining opportunities is $15 if the contract is refused. Since this contract can be served with all sports opportunities, then there are 1000 finance and 250 sports opportunities remaining, and the remaining value is $11.25: thus, the difference is $3.75. Note that this is exactly the cost of the impressions that the contract received.

On the other hand, if a new advertiser came and asked for a second contract of 750 opportunities of finance or sports, then the cost would be higher. The value of the remaining impressions if the second contract is not taken is $11.25.

On the other hand, only 500 finance impressions will remain, so the remaining value if the contract is accepted is $5, so the second contract would cost $6.25.

If there was a third contract for 500 sports impressions, it would cost $5, because accepting it would involve rearranging the first two contracts and using up all the valuable finance impressions.

In terms of a more complex analysis, the value of possible future contracts may be considered. For instance, one might expect that there may be advertisers, and therefore contracts, that will be interested in a number of impressions from any property, implying that as the number of remaining opportunities grows smaller, all impressions become more expensive. Also, one might consider possible future contracts that are frequency capped. This may result in opportunities of users who visit less frequently to be more valuable, due to the fact that they will reduce the number of contracts with maximum possible reach (number of users that have seen the contract).

A more precise methodology for optimizing the price of a contract may also be utilized. To begin with, a set ∪ user samples are drawn. The following are defined:
a) Oᵤ is the set of opportunities associated with u ∈ U (UserSample.opportunities). For the sake of convenience, assume that each opportunity is a separate copy (i.e., two opportunities from two different users or even two opportunities from the same user at different times will not be considered “equal” in terms of the union of sets and so forth).
b) O=∪_{u∈U} Oᵤ is the set of all opportunities in the samples.
c) wᵤ is the weight of each sample (u.weight).
d) L is the set of contracts.
e) For all l ∈ L, gₗ is the guarantee of contract l.
f) For each u ∈ U, for each impression k in {1 . . . u.opportunities.size( )}, if o=u.opportunities.get(k), then define Lₒ⊂ L such that Lₒ=u.targets:get(l), which it can serve. These Lₒ are combined into L*⊂ O×L,where (o,l) ∈ L* if and only if l ∈ Lₒ.
g) For each l ∈L, Tₗ ⊂ O is the set of opportunities that can serve contract 1, or more formally, o∈Tₗ if l∈Lₒ.

Finally, there are a set of ad groups Gr where each G ∈ Gr is a set of contracts. Ad groups may have a frequency cap, which is denoted c_{G}. Define T_{l,u}=Tₗ∩Oᵤ, T*_{l,u}=T_{l,u}×{l}. For each G ∈ Gr, define T*_{G,u}=∪_{l∈G,u}T*_{l,u}. Define T* ⊂Gr×U to be the set of all G; u such that T*_{G,u} is nonempty.

These are then input to the pricing optimization problem. The output are the variables {s_{o,l}: (o,l)∈ L*}. The following equations represent how impressions are to be served to the various contracts from the various contracts.

$$\begin{matrix}{s}_{o , l} \geq 0 \\ ∀ ( 0 , l ) ∈ {L}^{*} & ( 1 ) \\ {\sum }_{l ∈ {L}_{o}} {s}_{o , l} \geq {w}_{u} \\ ∀ u ∈ U , ∀ o ∈ {O}_{U} & ( 2 ) \\ {\sum }_{l ∈ {L}_{o}} {s}_{o , l} \geq {g}_{t} \\ ∀ l ∈ L & ( 3 ) \\ {\sum }_{( 0 , l ) ∈ {T}_{G , u}^{*}} {s}_{o , l} \leq {C}_{G} \\ ∀ ( G , u ) ∈ {T}^{*} & ( 4 )\end{matrix}$$

In addition to the particulars of each existing contract, there may be an expected value of remaining inventory. In particular, suppose that vₒ is the value of each opportunity. The remainder r₀=(wᵤ−Σ_{l∈L}_{ₒ} sₒ,l), so the remaining value is rₒvₒ. To determine an optimal base price for the contract,

$${\sum }_{o ∈ O} ( {w}_{u} - {\sum }_{l ∈ {L}_{o}} {s}_{o} , l )$$

is maximized subject to constraints 1-4 above. This formula is an online linear programming problem that may be solved via programs such as CPLEX and Ipsolve.

FIG. 8 describes how the equations above are utilized to determine an optimal base price for a contract. Referring to FIG. 8, at block 800, user samples are assembled. Assembly of the user samples may be accomplished via the methodology described above in FIG. 5.

At block 805, the value of each remaining piece of impression inventory may be calculated. Each piece of impression inventory may correspond to an opportunity as defined above and may be associated with a user sample. For example, a sample based on a user that on a given day visited a sports web page once and a finance web page once may represent two opportunities, or two pieces of impression inventory. The weight of the sample may also be considered. So, for example, if the user sample above represented 1000 individuals, then the sample actually represents 2000 pieces of impression inventory.

At block 810, the value associated with all of the available inventory before booking a contract may be determined by maximizing the formula

$${\sum }_{o ∈ O} ( {w}_{u} - {\sum }_{l ∈ {L}_{o}} {s}_{o} , l )$$

subject to constraints (1)-(4) above. This is an online linear programming problem and may be solved via programs, such as CPLEX and Ipsolve.

At block 815, the value associated with all of the available inventory after booking a contract may be determined. The value may also be determined via the formula of block 810.

At block 820, the base price for the contract is computed. The base price corresponds to the difference between the value of the remaining inventory computed at blocks 815 and 810.

The difference in base price of the contracts derived via the operations of FIG. 8 and the original problem may be shown by way of example.

Consider the earlier example regarding finance and sports. However, in this example the following additional pieces of information are specified

1) 250 sports visitors visited once.

2) 250 sports visitors visited three times.

3) 250 finance visitors visited once.

4) 250 finance visitors visited three times.

So, if a contract with a frequency cap of 1 requests 750 opportunities, then that contract can only be allocated 500 sports impressions. Therefore, the cost to book the contract would be $15−$10=$5. If the second contract did not have a frequency cap, that contract would be allocated 500 sports impressions and 250 finance impressions, and amount of remaining inventory left would be 500 finance impressions, with a value of $5. Therefore, the second contract would cost $5. As shown, frequency capping can in fact influence the price of a contract.

The procedures above may be modified by adding hypothetical contract L^{h}. First, L^{r} is defined to be the real contract, with L=L^{r} ∪ L^{h}. The distinction in this case is that the hypothetical contracts are optional. These l ∈ L^{h} have a hypothetical price per opportunity pₗ. Maximizing

$${\sum }_{o ∈ O} ( {w}_{u} - {\sum }_{l ∈ {L}_{o}} {s}_{o} , l ) + {\sum }_{{l}^{′} ∈ {L}^{h}} pv {\sum }_{l ∈ {T}_{l}} {s}_{o} , l$$

subject to the constraints above yields an optimal contract price based on hypothetical contracts. For instance, suppose a hypothetical contract with a frequency cap of 1 and a demand of 1000 (sports or finance) is added, and the advertiser is willing to spend $20 CPM. In this cases, the initial value of the remaining items is $27.50. Consider then several different first contracts:
1. A contract for 750 of either sports or finance. Then it will use up 500 sports impressions and 250 finance impressions, leaving the hypothetical contract alone. The remaining value is the value of the hypothetical contract and the remaining 250 finance opportunities, or $20+$2.50. So the contract costs $5.
2. A frequency capped contract (with a frequency cap of 1) for 750 of either sports or finance. The contract takes 500 sports impressions and 250 finance impressions, but has to take 250 impressions from those who visited sports once, meaning that there are only 750 impressions remaining for the hypothetical contract. So the remaining value is now $15+$1.25+$2.50=$18.75. Therefore the contract costs $8.75.

Thus, this measure of pricing allows one to calculate all the consequences of accepting a contract at a given point in time.

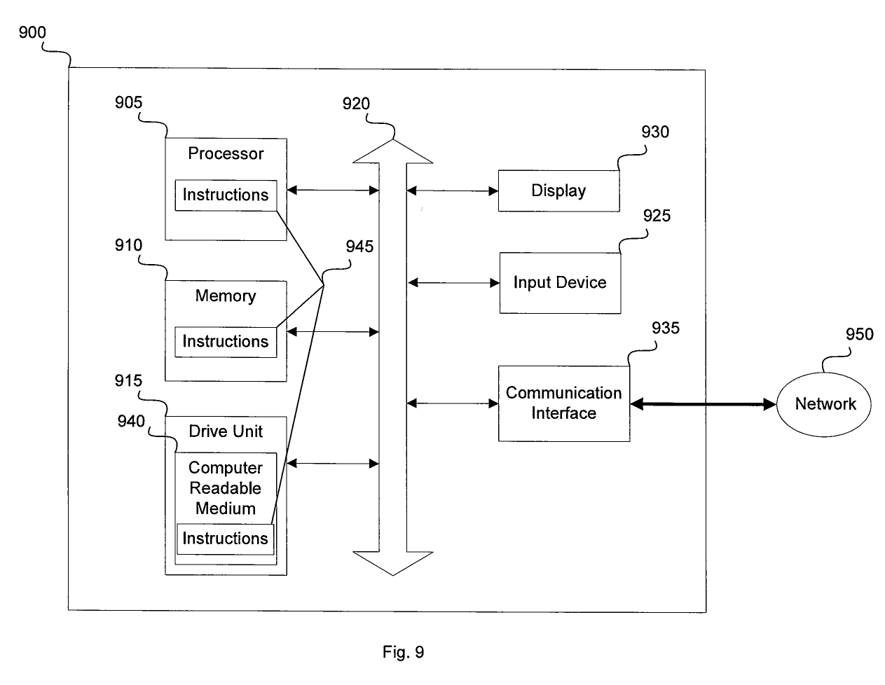

FIG. 9 illustrates a general computer system 900, which may represent the processor 105, the admission control subsystem 110, and/or the ad server 125 of FIG. 1, or any of the other computing devices referenced herein. The computer system 900 may include a set of instructions 945 that may be executed to cause the computer system 900 to perform any one or more of the methods or computer-based functions disclosed herein. The computer system 900 may operate as a stand-alone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 900 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 945 (sequential or otherwise) that specify actions to be taken by that machine. In one embodiment, the computer system 900 may be implemented using electronic devices that provide voice, video or data communication. Further, while a single computer system 900 may be illustrated, the term “system” shall also be taken to include any collection of systems or sub-systems that individually or jointly execute a set, or multiple sets, of instructions to perform one or more computer functions.

As illustrated in FIG. 9, the computer system 900 may include a processor 905, such as a central processing unit (CPU), a graphics processing unit (GPU), or both. The processor 905 may be a component in a variety of systems. For example, the processor 905 may be part of a standard personal computer or a workstation. The processor 905 may be one or more general processors, digital signal processors, application specific integrated circuits, field programmable gate arrays, servers, networks, digital circuits, analog circuits, combinations thereof, or other now known or later-developed devices for analyzing and processing data. The processor 905 may implement a software program, such as code generated manually (i.e., programmed).

The computer system 900 may include a memory 910 that can communicate via a bus 920. For example, the impression inventory database 115, user sample database 120, and/or the advertisement database 130 of FIG. 1 may be stored in the memory. The memory 910 may be a main memory, a static memory, or a dynamic memory. The memory 910 may include, but may not be limited to, computer readable storage media such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one case, the memory 910 may include a cache or random access memory for the processor 905. Alternatively or in addition, the memory 910 may be separate from the processor 905, such as a cache memory of a processor, the system memory, or other memory. The memory 910 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 910 may be operable to store instructions 945 executable by the processor 905. The functions, acts or tasks illustrated in the figures or described herein may be performed by the programmed processor 905 executing the instructions 945 stored in the memory 910. The functions, acts or tasks may be independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 900 may further include a display 930, such as a liquid crystal display (LCD), an organic light emitting diode (OLED), a flat panel display, a solid state display, a cathode ray tube (CRT), a projector, a printer or other now known or later-developed display device for outputting determined information. The display 930 may act as an interface for the user to see the functioning of the processor 905, or specifically as an interface with the software stored in the memory 910 or in the drive unit 915.

Additionally, the computer system 900 may include an input device 925 configured to allow a user to interact with any of the components of system 900. The input device 925 may be a number pad, a keyboard, or a cursor control device, such as a mouse, or a joystick, touch screen display, remote control or any other device operative to interact with the system 900.

The computer system 900 may also include a disk or optical drive unit 915. The disk drive unit 915 may include a computer-readable medium 940 in which one or more sets of instructions 945, e.g. software, can be embedded. Further, the instructions 945 may perform one or more of the methods or logic as described herein. The instructions 945 may reside completely, or at least partially, within the memory 910 and/or within the processor 905 during execution by the computer system 900. The memory 910 and the processor 905 also may include computer-readable media as discussed above.

The present disclosure contemplates a computer-readable medium 940 that includes instructions 945 or receives and executes instructions 945 responsive to a propagated signal, so that a device connected to a network 950 may communicate voice, video, audio, images or any other data over the network 950. The instructions 945 may be implemented with hardware, software and/or firmware, or any combination thereof. Further, the instructions 945 may be transmitted or received over the network 950 via a communication interface 935. The communication interface 935 may be a part of the processor 905 or may be a separate component. The communication interface 935 may be created in software or may be a physical connection in hardware. The communication interface 935 may be configured to connect with a network 950, external media, the display 930, or any other components in system 900, or combinations thereof. The connection with the network 950 may be a physical connection, such as a wired Ethernet connection or may be established wirelessly as discussed below. Likewise, the additional connections with other components of the system 900 may be physical connections or may be established wirelessly.

The network 950 may include wired networks, wireless networks, or combinations thereof. The wireless network may be a cellular telephone network, an 802.11, 802.16, 802.20, or WiMax network. Further, the network 950 may be a public network, such as the Internet, a private network, such as an intranet, or combinations thereof, and may utilize a variety of networking protocols now available or later developed including, but not limited to, TCP/IP based networking protocols.

The computer-readable medium 940 may be a single medium, or the computer-readable medium 940 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 940 may include a solid-state memory such as a memory card or other package that houses one or more non-volatile read-only memories. The computer-readable medium 940 also may be a random access memory or other volatile re-writable memory. Additionally, the computer-readable medium 940 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

Accordingly, the method and system may be realized in hardware, software, or a combination of hardware and software. The method and system may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The method and system may also be embedded in a computer program product, which includes all the features enabling the implementation of the methods described herein and which, when loaded in a computer system, is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

From the foregoing, it may be seen that the embodiments disclosed herein provide an approach for allocating impression inventory to contracts for booking internet advertising space, and also for determining a price associated with the contract.

While the method and system has been described with reference to certain embodiments, it will be understood by those skilled in the art that various changes may be made and equivalents may be substituted without departing from the scope. In addition, many modifications may be made to adapt a particular situation or material to the teachings without departing from its scope. Therefore, it is intended that the present method and system not be limited to the particular embodiment disclosed, but that the method and system include all embodiments falling within the scope of the appended claims.

We claim:

1. A method for determining a price of a contract for booking advertising space in a networked environment, the method comprising:
receiving, via a web server, a request to book a number of impressions from available impression inventory, where each impression corresponds to the delivery of an advertisement to a browser;
assembling, at a processor, a plurality of user samples that represent a total amount of impression inventory, where each user sample represents a number of internet users;
calculating a value associated with each piece of remaining impression inventory of the total impression inventory, where each piece of remaining impression inventory corresponds to impression inventory that has not been allocated;
evaluating a value of all remaining impression inventory before allocation to a contract according to a set of equations;
evaluating a value of all remaining impression inventory after allocation of inventory to the contract according to the set of equations;
generating a base price to be associated with the request to book the number of impressions, the base price corresponding to the difference between the value of the remaining inventory before and after the inventory was allocated to the contract; and
communicating, via the web server, the base price.

2. The method according to claim 1, further comprising:
sampling an inventory of display impressions to produce the user samples;
determining a weight associated with each user sample of the user samples;
determining a number of impressions delivered to each user sample of the set of user samples; and
storing, to a user sample database, data that defines each user sample, the weight associated with each user sample, and the number of impressions delivered to each user sample.

3. The method according to claim 1, wherein the weight associated with each user sample corresponds to a number of users the user sample represents.

4. The method according to claim 1, further comprising maximizing
$${\sum }_{o ∈ O} ( {w}_{u} - {\sum }_{l ∈ {L}_{o}} {s}_{o} , l ) ,$$
subject to constraints of:
$$\begin{matrix}{s}_{o , l} \geq 0 & ∀ ( 0 , l ) ∈ {L}^{*} \\ {\sum }_{l ∈ {L}_{o}} {s}_{o , l} \geq {w}_{u} & ∀ u ∈ U , ∀ o ∈ {O}_{U} \\ {\sum }_{l ∈ {L}_{o}} {s}_{o , l} \geq {g}_{t} & ∀ l ∈ L \\ {\sum }_{( 0 , l ) ∈ {T}_{G , u}^{*}} {s}_{o , l} \leq {C}_{G} & ∀ ( G , u ) ∈ {T}^{*}\end{matrix}$$
where U is a set of user samples and u ∈ U, wᵤ is a weight of each sample, L is a set of contracts, and l ∈ L.

5. The method according to claim 4, further comprising maximizing an equation via at least one of: LPSOLVE, CPLEX, and a system that solves linear program problems.

6. The method according to claim 1, further comprising maximizing
$${\sum }_{o ∈ O} ( {w}_{u} - {\sum }_{l ∈ {L}_{o}} {s}_{o} , l ) + {\sum }_{{l}^{′} ∈ {L}^{h}} pv {\sum }_{l ∈ {T}_{l}} {s}_{o} , l ,$$
subject to constraints of:
$$\begin{matrix}{s}_{o , l} \geq 0 & ∀ ( 0 , l ) ∈ {L}^{*} \\ {\sum }_{l ∈ {L}_{o}} {s}_{o , l} \geq {w}_{u} & ∀ u ∈ U , ∀ o ∈ {O}_{U} \\ {\sum }_{l ∈ {L}_{o}} {s}_{o , l} \geq {g}_{t} & ∀ l ∈ L \\ {\sum }_{( 0 , l ) ∈ {T}_{G , u}^{*}} {s}_{o , l} \leq {C}_{G} & ∀ ( G , u ) ∈ {T}^{*}\end{matrix}$$
where U is a set of user samples and u ∈ U, wᵤ is a weight of each sample, L is a set of contracts, and l ∈ L.

7. The method according to claim 6, further comprising maximizing an equation via at least one of: LPSOLVE, CPLEX, and a system that solves linear program problems.

8. A machine-readable storage medium having stored thereon, a computer program comprising at least one code section for determining a price of a contract for booking advertising space in a networked environment, the at least one code section being executable by a machine for causing the machine to perform acts of:
receiving, via a web server, a request to book a number of impressions from available impression inventory, where each impression corresponds to the delivery of an advertisement to a browser;
assembling, at a processor, a plurality of user samples that represent a total amount of impression inventory, where each user sample represents a number of internet users;
calculating a value associated with each piece of remaining impression inventory of the total impression inventory, where each piece of remaining impression inventory corresponds to impression inventory that has not been allocated;
evaluating a value of all remaining impression inventory before allocation to a contract according to a set of equations;
evaluating a value of all remaining impression inventory after allocation inventory to the contract according to the set of equations;
generating a base price to be associated with the request to book the number of impressions, the base price corresponding to the difference between the value of the remaining inventory before and after the inventory was allocated to the contract; and
communicating, via the web server, the base price.

9. The machine-readable storage according to claim 8, wherein the at least one code section comprises code that enables:
sampling an inventory of display impressions to produce the user samples;
determining a weight associated with each user sample of the user samples;
determining a number of impressions delivered to each user sample of the set of user samples; and
storing, to a user sample database, data that defines each user sample, the weight associated with each user sample, and the number of impressions delivered to each user sample.

10. The machine-readable storage according to claim 8, wherein the weight associated with each user sample corresponds to a number of users the user sample represents.

11. The machine-readable storage according to claim 8, wherein the at least one code section comprises code that enables maximizing
$${\sum }_{o ∈ O} ( {w}_{u} - {\sum }_{l ∈ {L}_{o}} {s}_{o} , l ) ,$$
subject to constraints of:
$$\begin{matrix}{s}_{o , l} \geq 0 & ∀ ( 0 , l ) ∈ {L}^{*} \\ {\sum }_{l ∈ {L}_{o}} {s}_{o , l} \geq {w}_{u} & ∀ u ∈ U , ∀ o ∈ {O}_{U} \\ {\sum }_{l ∈ {L}_{o}} {s}_{o , l} \geq {g}_{t} & ∀ l ∈ L \\ {\sum }_{( 0 , l ) ∈ {T}_{G , u}^{*}} {s}_{o , l} \leq {C}_{G} & ∀ ( G , u ) ∈ {T}^{*}\end{matrix}$$
where U is a set of user samples and u ∈U, wᵤ is a weight of each sample, L is a set of contracts, and l ∈ L.

12. The machine-readable storage according to claim 11, wherein the at least one code section comprises code that enables maximizing an equation via at least one of: LPSOLVE, CPLEX, and a system that solves linear program problems.

13. The machine-readable storage according to claim 8, wherein the at least one code section comprises code that enables maximizing
$${\sum }_{o ∈ O} ( {w}_{u} - {\sum }_{l ∈ {L}_{o}} {s}_{o} , l ) + {\sum }_{{l}^{′} ∈ {L}^{h}} pv {\sum }_{l ∈ {T}_{l}} {s}_{o} , l ,$$
subject to constraints of:
$$\begin{matrix}{s}_{o , l} \geq 0 & ∀ ( 0 , l ) ∈ {L}^{*} \\ {\sum }_{l ∈ {L}_{o}} {s}_{o , l} \geq {w}_{u} & ∀ u ∈ U , ∀ o ∈ {O}_{U} \\ {\sum }_{l ∈ {L}_{o}} {s}_{o , l} \geq {g}_{t} & ∀ l ∈ L \\ {\sum }_{( 0 , l ) ∈ {T}_{G , u}^{*}} {s}_{o , l} \leq {C}_{G} & ∀ ( G , u ) ∈ {T}^{*}\end{matrix}$$
where U is a set of user samples and u ∈U, wᵤ is a weight of each sample, L is a set of contracts, and l ∈ L.

14. The machine-readable storage according to claim 13, wherein the at least one code section comprises code that enables maximizing an equation via at least one of: LPSOLVE, CPLEX, and a system that solves linear program problems.

15. A system for determining a price of a contract for booking advertising space in a networked environment, the system comprising:
an admission control subsystem operable to receive a request to book a number of impressions from available impression inventory, where each impression corresponds to the delivery of an advertisement to a browser;
a processor operable to assemble a plurality of user samples that represent a total amount of impression inventory, where each user sample represents a number of internet users; calculate a value associated with each piece of remaining impression inventory of the total impression inventory, where each piece of remaining impression inventory corresponds to impression inventory that has not been allocated; evaluate a value of all remaining impression inventory before allocation to a contract according to a set of equations; evaluate a value of all remaining impression inventory after allocation inventory to the contract according to the set of equations; generate a base price to be associated with the request to book the number of impressions, the base price corresponding to the difference between the value of the remaining inventory before and after the inventory was allocated to the contract; and communicate the base price to the admission control subsystem.

16. The system according to claim 15, wherein the processor is operable to:
sample an inventory of display impressions to produce the user samples;
determine a weight associated with each user sample of the user samples;
determine a number of impressions delivered to each user sample of the set of user samples; and
store, to a user sample database, data that defines each user sample, the weight associated with each user sample, and the number of impressions delivered to each user sample.

17. The system according to claim 15, wherein the weight associated with each user sample corresponds to a number of users the user sample represents.

18. The system according to claim 15, wherein the processor is operable to maximize
$${\sum }_{o ∈ O} ( {w}_{u} - {\sum }_{l ∈ {L}_{o}} {s}_{o} , l ) ,$$
subject to constraints of:
$$\begin{matrix}{s}_{o , l} \geq 0 & ∀ ( 0 , l ) ∈ {L}^{*} \\ {\sum }_{l ∈ {L}_{o}} {s}_{o , l} \geq {w}_{u} & ∀ u ∈ U , ∀ o ∈ {O}_{U} \\ {\sum }_{l ∈ {L}_{o}} {s}_{o , l} \geq {g}_{t} & ∀ l ∈ L \\ {\sum }_{( 0 , l ) ∈ {T}_{G , u}^{*}} {s}_{o , l} \leq {C}_{G} & ∀ ( G , u ) ∈ {T}^{*}\end{matrix}$$
where U is a set of user samples and u ∈ U, wᵤ is a weight of each sample, L is a set of contracts, and l ∈ L.

19. The system according to claim 18, wherein the processor is operable to maximize an equation via at least one of: LPSOLVE, CPLEX, and a system that solves linear program problems.

20. The system according to claim 15, wherein the processor is operable to maximize
$${\sum }_{o ∈ O} ( {w}_{u} - {\sum }_{l ∈ {L}_{o}} {s}_{o} , l ) + {\sum }_{{l}^{′} ∈ {L}^{h}} pv {\sum }_{l ∈ {T}_{l}} {s}_{o} , l ,$$
subject to constraints of:
$$\begin{matrix}{s}_{o , l} \geq 0 & ∀ ( 0 , l ) ∈ {L}^{*} \\ {\sum }_{l ∈ {L}_{o}} {s}_{o , l} \geq {w}_{u} & ∀ u ∈ U , ∀ o ∈ {O}_{U} \\ {\sum }_{l ∈ {L}_{o}} {s}_{o , l} \geq {g}_{t} & ∀ l ∈ L \\ {\sum }_{( 0 , l ) ∈ {T}_{G , u}^{*}} {s}_{o , l} \leq {C}_{G} & ∀ ( G , u ) ∈ {T}^{*}\end{matrix}$$
where U is a set of user samples and u ∈ U, wᵤ is a weight of each sample, L is a set of contracts, and l ∈ L.

21. The system according to claim 20, wherein the processor is operable to maximize an equation via at least one of: LPSOLVE, CPLEX, and a system that solves linear program problems.
